(19) United States
(12) Patent Application Publication
(10) Pub. No.: US 2016/0127930 A1
(43) Pub. Date: May 5, 2016

(54) WIRELESS SYSTEM

(71) Applicant: CELLULAR SOUTH, INC. DBA C SPIRE WIRELESS, Ridgeland, MS (US)

(72) Inventors: Thomas Nguyen, Renton, WA (US); Eric Graham, Flowood, MS (US)

(73) Assignee: CELLULAR SOUTH, INC. DBA C SPIRE WIRELESS, Ridgeland, MS (US)

(21) Appl. No.: 14/894,534

(22) PCT Filed: May 30, 2014
(86) PCT No.: PCT/US14/40251

§ 371 Date: Nov. 29, 2015

Related U.S. Application Data
(60) Provisional application No. 61/830,023, filed on May 31, 2013.

(51) Int. Cl. H04W 24/08

(52) U.S. Cl. CPC H04W 24/08; H04W 88/16

(57) ABSTRACT

The present invention provides a system that provides and extends wireless RF signals to any distance location beyond the normal transmission/broadcast of cellular tower utilizing a existing network. The system provides wireless communication carried by wire lines for communication and testing between remote locations in real-time.

### CLAIM OF PRIORITY

This application claims the benefit of prior U.S. Provisional Patent Application No. 61/830,023, filed on May 31, 2013, which is hereby incorporated by reference in its entirety.

### FIELD OF INVENTION

The present invention relates to a system that provides and extends wireless RF signals to any distance location beyond the normal transmission/broadcast of cellular tower. In particular, a system where wireless communication is carried by wire lines for communication and testing between remote locations in real-time,

### BACKGROUND OF THE INVENTION

For wireless telecommunication application, a device such as a cell phone receives RF signals set under wireless transmission standards commonly known as either CDMA or GSM on 2G, 3G, and LTE on 4G.

The 2G is known as the second generation cell phone, primary to provide consumers the mobility in voice call. The 3G is third generation standard created to provide faster data rates to provide users the mobility while accessing data such as Internet or emails communication. The 4^{th} generation (4G) includes LTE (Long Term Evolution) standard. The terms 2G/3G/4G may not be clearly defined, as each may include various wireless telecommunication standards. For example, LTE and WiMax may both claim to be 4G technologies. 3G standards may include, CDMA 1×RTT (Single Carrier Radio Transmission Technology) or EvDO (Enhanced Voice-Data Optimized), Universal Mobile Telecommunications System (UMTS), WCDMA, and TD-SCDMA used in China.

Modern cellular devices are designed to accommodate a plurality of the standards discussed above,

Another type of wireless communication standard is commonly known as “Wi-Fi.” Wi-Fi networks use radio technologies called 802.11 (developed and controlled by IEEE) for wireless connectivity. A Wi-Fi network can be used to connect electronic devices to each other, to the internet, and to the wired networks which use Ethernet technology. Wi-Fi networks operate in the 2.4 and 5 GHz radio bands, with some products that contain both bands (dual band).

### SUMMARY OF THE INVENTION

The present invention provides a system that provides and extends wireless RF signals to any distance location beyond the normal transmission/broadcast of cellular tower utilizing an existing network. The system provides wireless communication carried by wire lines for communication and testing between remote locations in real-time.

The present invention includes a pair of receiver/transmitter in order to receive/transmit RF signals from/to the wireless base station via opened airwave environment.

The received/transmitted RF signals are digitized then transported from originating router R1 to targeted router R2, or R3 and etc. for research & development (R&D) purposes, under an enclosed environment such as RF chamber.

The digitized RF signals from router R1 is transported as data packets, to router R2. Once the targeted router R2, R3 . . . receives the data packets, it decodes the digitized packets, and converts such information to RF signals. The transmitter resides within each router is tasked to transmit the converted RF signals accordingly.

The converted RF signals are then broadcast by the targeted router R2, R3 . . . within an enclosed RF chamber for R&D purposes only, It is not intended to broadcast via opened airwave unless it is authorized by government office according to spectrum license regulations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The details of one or more embodiments are set forth in the following detailed description of the invention and the accompanying drawings. Other objectives, features, and advantages of the invention will be more readily understood upon consideration of the following Detailed Description of the invention, taken in conjunction with the accompanying drawings, and with the claims.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates an embodiment of present invention.

FIG. 2 illustrates an embodiment of Rx/Tx 140.

FIG. 3 illustrates a system according to the present invention.

### DETAILED DESCRIPTION OF THE SYSTEM

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not specifically included in the embodiments.

Real world environment with real time network responses cannot be emulated in a lab. Therefore, any new wireless devices must be tested at multiple locations, cities, states, or countries to ensure the device RF and network related performance are qualified for consumer's safety and usage.

However, current industry practice is not highly efficient due to travel costs associated with multiple locations testing, and lose valuable research & development (R&D) cycle time due to actual travel by car or by planes, Thus the present invention will address such needs to save time and costs during product R&D cycle.

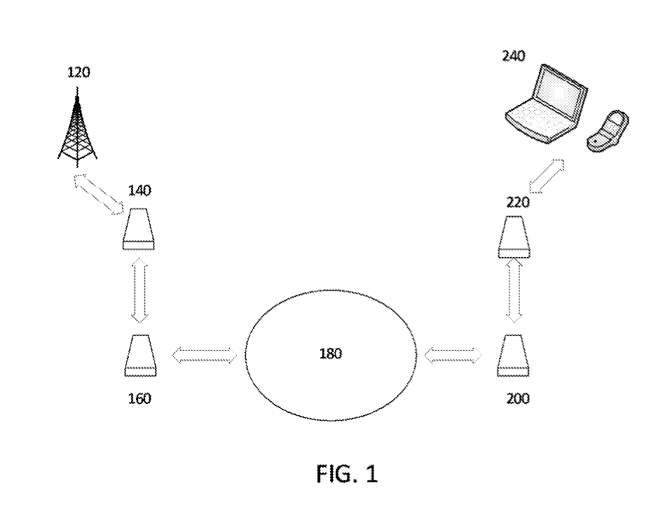

The present invention provides a system that could bring real-time field testing environments into the R&D centers. An embodiment is illustrated in FIG. 1. The system includes a pair of receiver/transmitter (Rx/Tx) 140 receiving/transmitting wireless RF signal from a base station 120. The receiver/transmitter (Rx/Tx) 140 receives the RF signal in accordance with a wireless communication standard such as 2G, 3G, 4G, or 802.11. The RF signals from an originating router are digitized then transported as data packets to a targeted router.

There are several ways to convert a wireless RF signal to digital. In a mobile phone application, the most common method is direct conversion. In direct conversion, the received RF signal is first down-converted to a base (or near base) frequency using a mixer. Then the base (or near base) frequency signal is filtered and then converted to digital using an analog-to-digital converter (ADC). More traditionally, the receiver may employ a superheterodyne architecture. In a superheterodyne receiver, the received RF is first down-converted to an intermediate frequency (i.e., a frequency between the received RF signal and the base signal). in the next stage, the intermediate-frequency signal is converted to a base frequency signal, and then converted to a digital signal using ADC.

In one embodiment, the Rx/Tx 140 includes a central processing unit (CPU) for executing instructions in response to commands, and a communication device for sending and receiving wireless signals. One example of the communication device is a known as an RF front end using an antenna. Other examples include a communication card, a satellite dish, an antenna, a network adapter, or some other mechanism capable of transmitting and receiving wireless signals.

The Rx/Tx 140 may also include an input/output interface that enables wired or wireless connection to various peripheral devices, such as a network router. Examples of the Rx/Tx 140 include, but are not limited to, a mobile phone, a personal digital assistant (PDA), a laptop computer, and an audiovisual input device. In one implementation, a processor-based system of the general-purpose computer can include a main memory, preferably random access memory (RAM), and can also include a secondary memory, which may be a tangible computer-readable medium. The secondary memory can include, for example, a hard disk drive or a removable storage drive, representing a floppy disk drive, an optical disk drive (Blu-Ray, DVD, CD drive), standalone RAM disks, Iomega Zip drive, etc. The removable storage drive can read from or write to a removable storage medium. A removable storage medium can include magnetic tape, optical disk (Blu-Ray disc, DVD, CD) a memory card (CompactFlash card, Secure Digital card, USB Memory Stick), etc., which can be removed from the storage drive used to perform read and write operations. As will be appreciated, the removable storage medium can include computer software or data.

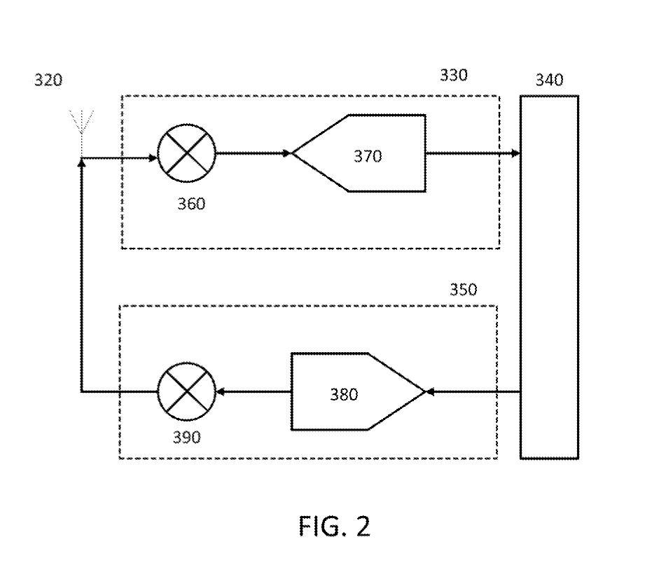

FIG. 2 illustrates an embodiment of an RF front end of the Rx/Tx 140, The Rx/Tx 140 includes an antenna 320 to receive and transmit wireless RF signals. The receiver portion 330 manipulates and digitizes the received RF signal. The transmitter portion 350 converts digital signals back to analog RF signals for transmission,

In one embodiment, the Rx/Tx 140 employs the direct-conversion scheming for receiving. Other receiving schemes such as the heterodyne architecture may be used. In this embodiment, a mixer 360 down-converts the received RF into a baseband signal. To transmit a signal wirelessly, the base signal is typically combined with a high frequency carrier signal. The high frequency carrier signal contains more energy and thus may be transmitted a longer distance.

The analog-to-digital converter (ADC) 370 then digitizes the down-converted signal into a digital signal in accordance with conventional art. The resulting digitized RF signal is then provided to a digital processing portion 340, which may perform various functions. In one embodiment, the digital processing portion 340 packetizes the digital RF signal, and sends the packets to a network router to be routed to a destination over a network.

In a transmission operation, the digital processing portion 340 receives packets from a network router, which receives the packets from a remote router via a network such as the internet. In one embodiment, the digital processing portion 340 extracts data or payloads from the packets and reconstitutes a digital RF signal from the payloads.

In one embodiment, the packets include timestamps and other timing information to allow the reconstitution of the RF signal with accurate timing information.

The transmitter portion 350 converts digital signals back to analog RF signals for transmission via the antenna 320. The transmitter portion 350 includes a digital-to-analog converter DAC) 380 that converts the digital RF signal to analog in accordance with conventional art. The mixer 390 then combines or mixes the base digital RF signal with a high frequency carrier signal to ready it for transmission.

In one embodiment, the Rx/Tx 140 includes one or a plurality of receiving schemes to digitize the received RF signal to emulate the testing device. In one embodiment, the digitized RF signal is provided to a network router (i.e., an originating router) 160 and is converted to packets in accordance with conventional art. In another embodiment, the Rx/Tx 140 converts the digitized RF signal into packers and sends the packets.

That is, the digitized RF signal is placed in the data (payload) portions of the packets. A packet, for example, includes a header portion that carries information, such as the destination device address that allows the packet to be transmitted and received via a network.

In one embodiment, the digitized RF signal is provided to a network router 160 and is converted to packets in accordance with conventional art. In another embodiment, the Rx/Tx 140 converts the digitized RF signal into packers and sends the packets to the network router 160.

In one embodiment, the network router 160 includes a central processing unit (CPU) for executing instructions in response to commands, and a communication device for sending and receiving wireless signals. One example of the communication device is a known as an RF front end using an antenna. Other examples include, a communication card, a satellite dish, an antenna, a network adapter, or some other mechanism capable of transmitting and receiving wireless signals.

The network router 160 may also include an input/output interface that enables wired or wireless connection to various peripheral devices and networks, an Ethernet or Internet. In one implementation, a network router 160 is a processor-based system of the general-purpose computer can include a main memory, preferably random access memory (RAM), and can also include a secondary memory, which may be a tangible computer-readable medium 120. The secondary memory can include, for example, a hard disk drive or a removable storage drive, representing a floppy disk drive, a magnetic tape drive, an optical disk drive (Blu-Ray, DVD, CD drive), magnetic tape, paper tape, punched cards, standalone RAM disks, Iomega Zip drive, etc. The removable storage drive can read from or write to a removable storage medium. A removable storage medium can include a floppy disk, magnetic tape, optical disk (Blu-Ray disc, DVD, CD) a memory card (CompactFlash card, Secure Digital card, Memory Stick), paper data storage (punched card, punched tape), etc., which can be removed from the storage drive used to perform read and write operations. As will be appreciated, the removable storage medium can include computer software or data.

In alternative embodiments, the secondary memory can include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer

In one embodiment, the packets further include timestamps that would preserve the timing information of the received RF signal. According, the digitized RF signal (carried by the payload portions of the packets) may be reconstituted.

The first network router 160 transmits the packets to a second network router 200 (i.e., a destination router) via a network 180. The network 180 may be the internet or an Ethernet network.

The second network router 200 receives the packets and reconstitutes the digitized RF signal, which is provided to an Rx/Tx 220. The Rx/Tx 220 converts the digitized signal back to an RF signal, and transmits the RF signal wireless in accordance with the same wireless standard (e.g., 3G, 4G, Wi-Fi) as received by the Rx/Tx 140.

A mobile device 240, such as a cell phone or a laptop computer receives the transmitted wireless signal. In one embodiment, the mobile device 240 is the device under testing. The second network router 200 (destination router) broadcasts (or broadcasts via Rx/Tx 140) the RF signal in an RF chamber i.e., an enclosed, protected space), and the mobile device 240 is placed within the RF chamber. Thus, the transmitted RF signal (to be received by the mobile device 240) is not broadcasted over open space.

According to the features of the above embodiment, testing of the mobile device 240 may take place remotely. Further, as would be understood by persons of ordinary skill in the art, RF signal may be transmitted by the mobile device 240 and received by the base station 120 as described above (but in a reversed direction).

II. Testing

One application of the disclosed system is (but not limited to) for testing of mobile devices remotely. For example, when a mobile phone company produces a new wireless smartphone, the new device needs to be tested in many locations. Using the system according to the present invention, a new phone could be tested to various degrees and in multiple environments remotely.

In one embodiment, the Rx/Tx 140 is a mobile system. In the testing process, Rx/Tx 140 is moved to various locations in the area covered by the base station 120. In this manner, location issues within the coverage area (such as a building block the RF signal) can be tested.

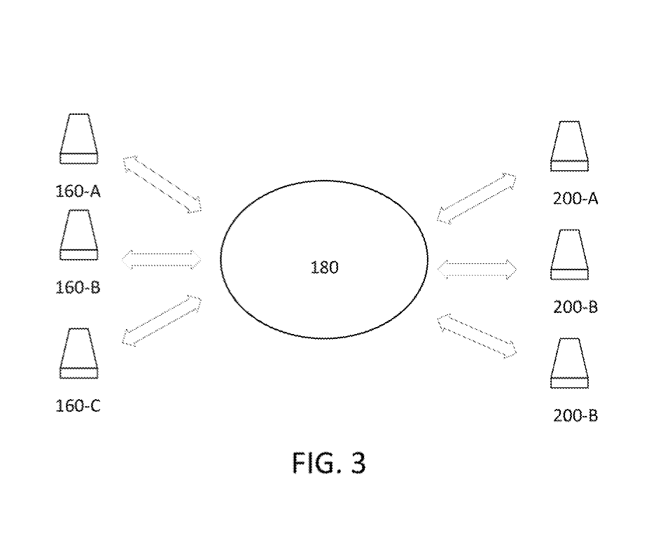

In another embodiment, the system includes individual Rx/Tx 140, originating router (network router) 160, destination router (network router) 200, and/or Rx/Tx 220 placed at numerous locations in different cities or countries covered by the base stations similar to base station 120. FIG. 3 illustrates an example of the system. A plurality of originating routers 160-A to 160-C are connected to an existing network 180. E.g., an internet network and one that is not dedicated to the described function. Likewise, a plurality of destination routers 200-A to 200-C are connected to the network 180. The system selects one or more of the originating routers 160-A to 160-C to transmits packets to selected one or more of the destination routers 200-A to 200-C, in accordance with embodiments of the present invention. In this manner, testing may take place over a plurality of areas or cities at the same time.

In another embodiment, the Rx/Tx 140 includes multiple antennae placed on various parts of the device. Each of the antennae (or a plurality of the antennae) may produce a packet stream of received RF signal.

In one embodiment, one of the antennae is selected for testing (i.e., transmitting and receiving packets of RF signal as discussed above). In another embodiment, one of the packet streams is selected (i.e., each of the antennae or a plurality of the antenna receives RF signal and produces packets of RF signals).

In another embodiment, one of more of the packet streams of RF signals may be stored in system. In this fashion, the stored packet streams may be reproduced later to emulate real-time testing.

The scope of present invention further includes any combination of the above embodiments. While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What the claimed is:

1. A wireless communication emulation system, comprising:
a mobile receiver/transmitter receiving/transmitting a wireless RF signal in accordance with a wireless communication standard from a base station;
a first network router generating originating RF signals to data packets, and transporting the data to targeted router;
a second network router receiving the data packets, and converting digitized data to RF signals;
a transmitter/receiver to generate an RF signal representing the received packets, and transmits the RF signal representing the received packets wirelessly.

2. The wireless communication emulation system of claim 1, wherein the first network router is the originated router at a first time, and is the targeted router at a second time.
